(19) United States
(12) Patent Application Publication
(10) Pub. No.: US 2015/0010025 A1
(43) Pub. Date: Jan. 8, 2015

(54) PULSED FIBER LASER WITH DOUBLE- PASS PUMPING

(71) Applicant: DATALOGIC AUTOMATION S.R.L., Monte San Pietro (BO) (IT)

(72) Inventors: Marco Tagliaferri, Taino (VA) (IT); Fabio Cannone, Melzo (MI) (IT); Daniela Nolli, Casale Corte Cerro (VA) (IT)

(21) Appl. No.: 14/369,273

(22) PCT Filed: Dec. 19, 2012
(86) PCT No.: PCT/IB2012/002748

§ 371 Date: Jun. 27, 2014

(30) Foreign Application Priority Data
Dec. 30, 2011 (IT) BG2011A000054

(51) Int. Cl. H01S 3/067; H01S 3/094

(52) U.S. Cl. CPC H01S 3/0675; H01S 3/094076
USPC 372/6

(57) ABSTRACT

A pulsed fiber laser oscillator comprising in succession: a pumping source (10) for providing pumping energy at a first wavelength to a multimode optical fiber; a first Bragg grating optical filter (11) reflecting a second wavelength and transparent to said first wavelength; an active optical fiber (20) having a predefined wavelength which emits radiation at said second wavelength; a switch (14) arranged to periodically interrupt said second wavelength to provide a pulsed laser beam; and a second Bragg grating optical filter (15) partially reflecting said second wavelength; characterized by comprising, following said active optical fiber (20), a reflector (21) of said first wavelength, such that said pumping energy undergoes two passages within said active optical fiber (20); said predefined wavelength being determined such that the absorption of said pumping energy at said first wavelength within said active optical fiber (20) is greater than 80% after undergoing said two passages.

The present invention relates to a pulsed fiber laser, more particularly to a pulsed fiber laser oscillator, and to a method for producing a pulsed fiber laser.

A pulsed laser emits pulses with a certain repetition frequency and duration. These pulses can be generated by different methods.

One of the most common pulse generation methods is to periodically interrupt a laser beam by active Q-switching which is based on modulating losses in the interior of the laser cavity.

To periodically interrupt the laser beam, use can be made for example of an opto-acoustic or opto-electric modulator configured to operate as a piloted shutter.

The Q-switching method can also be of passive type based on the use of a saturable absorber, which is a material the transmission of which increases when the light intensity exceeds a threshold value. Another pulse generation method is based on the gain switching technique which by modulating the pumping source current induces modulation of the fiber gain.

Of the various types of laser, fiber lasers are extremely compact and efficient, they have a high beam quality and a stability higher than that of lamp or diode pumped crystal lasers. Another crucial advantage over crystal lasers is the facility to scale the mean power while maintaining their quality and stability characteristics. Such lasers are increasingly more frequently used as light sources in industrial tagging systems. Typical specifications of these sources are: laser wavelength about 1 micron, average power in the range 5-30 W, pulse duration 10-200 ns at a repetition frequency of 1-200 kHz.

It is known to the expert of the art that short-duration (<200 ns) pulses of sufficient energy for the aforesaid industrial applications (average power 5-30 W) are generated by suitably modelling certain physical parameters of an active optical fiber oscillator including: the concentration of doped ions present in the active fiber (or in other words the pumping radiation absorption) and the length of the active fiber itself. However with pulsed fiber lasers using the aforedescribed methods there is a limit linked to the difficulty of achieving pulse duration of less than 200 ns particularly at high repetition frequencies such as 100 kHz. This fact is due mainly to is the commercial unavailability of an active optical fiber, typically but not exclusively a Ytterbium-doped fiber, with a high value of the pumping radiation absorption coefficient at 915 nm or 940 nm. Those active fibers which are commercially available are known to possess a high absorption level at 975 nm. However this absorption band is extremely narrow and less than 5 nm (FWHM) and hence the pumping sources at this wavelength require temperature stabilization. This stabilization reduces the system response rate, which is an essential characteristic for using the laser in tagging applications.

For this reason, it is preferred to work at absorption wavelengths at 915 nm and 940 nm, which manifest a lower absorption coefficient but a wider absorption band, typically of 20 nm.

The percentage pumping radiation absorbed by the active fiber is related to its length, for example an active fiber of length 3.5 metres, with an absorption coefficient of 2.3 dB/m, has an overall absorption of 8.0 dB, i.e. 84% of the pumping source power is absorbed. With optical fibers of greater absorption coefficients the percentages are higher, hence absorption coefficients greater than 80% are preferable.

The percentage of the pumping radiation absorbed by the active fiber is the percentage ratio between the power of the pumping energy leaving the active fiber and the entering power.

This is theoretically a good condition for ensuring a good laser efficiency in power terms.

It is noted that the value of the active fiber absorption is not the only physical parameter which has to be taken into consideration for optimizing the laser pulse duration. In fact, the theoretical model indicates that the laser pulse duration is directly proportional to the fiber length.

Hence the fiber length could be reduced as much as possible to obtain extremely short pulses, however reducing the active fiber length beyond a certain limit would have as its consequence a lesser pumping radiation absorption and hence a gain reduction resulting in an increase in the duration of the pulses produced. Commercially available active fibers impose a compromise between the power of the laser pulse generated in an oscillator and its time duration. In this respect, to maximize the pulse power the maximum pumping radiation should be obtained and hence the operation should be carried out with a fiber of a certain length. In contrast, this would produce pulses of a certain time duration. In practice, with the latest type of Ytterbium active fiber having double cladding and core dimensions and numerical aperture such as to ensure that a single mode beam or at most a nearly single mode beam is produced (V-number<3), which has an absorption of 2.3 dB/m at 915 nm, pulses of at most 200 ns are obtained with a repetition frequency of 100 kHz, whereas with other fiber models similar performance can be achieved only by increasing the pumping power by 100%, with a considerable increase in the feed current of the pumping diodes.

This evidently results in a reduction in the average time between oscillator failures (MTBF) and hence a reduction in system reliability. An object of the present invention is to provide a fiber laser oscillator with pulses generated by active and/or passive Q-switching and/or gain switching, which enables the performance of a pulsed fiber laser oscillator of the known art to be improved, and more particularly enables short-duration pulses to be obtained, especially at repetition frequencies higher than those obtainable in the known art.

Another object of the present invention is to provide a pulsed fiber laser oscillator of the active and/or passive Q-switching and/or gain switching type which enables the unavailability of active fibers of high pumping wavelength absorption to be overcome.

These and other objects are attained according to the present invention by a pulsed fiber laser oscillator comprising in succession: a pumping source for providing pumping energy at a first wavelength to a multimode optical fiber; a first Bragg grating optical filter reflecting a second wavelength and transparent to said first wavelength; an active optical fiber having a predefined wavelength which emits radiation at a second wavelength; a switch (14) arranged to periodically interrupt said second wavelength to provide a pulsed laser beam; and a second Bragg grating optical filter partially reflecting said second wavelength; characterized by comprising, following said active optical fiber, a reflector of said first wavelength, such that said pumping energy undergoes two passages within said active optical fiber, said predefined wavelength being determined such that the absorption of said pumping energy at said first wavelength within said active optical fiber is greater than 80% after undergoing said two passages.

These objects are also attained by a method for producing a pulsed fiber laser in accordance with claim 1.

Further characteristics of the invention are described in the dependent claims.

By virtue of the present invention a very high performance is achieved in terms of duration and repetition frequency or, alternatively, a performance comparable to that of the known art but with very low optical fiber pumping diode piloting powers and hence currents, so increasing system reliability.

To obtain a high absorption value at the pumping wavelength but at the same time a short active fiber wavelength in order to obtain pulses of shorter duration than the known art, an active fiber of reduced length (typically reducing it by 50%) is used, but causing it to be traversed twice by the pumping radiation, by positioning a pumping radiation reflector.

This reflector can be formed at a glass/air interface in a Q-switching fiber laser, either active or passive, located in the modulator before the modulator crystal.

This interface can be introduced into a gain switching laser by interrupting the fiber chain by introducing two optimally aligned fiber collimators.

The characteristics and advantages of the present invention will be apparent from the following detailed description of one embodiment thereof, illustrated by way of non-limiting example in the accompanying drawings, in which:

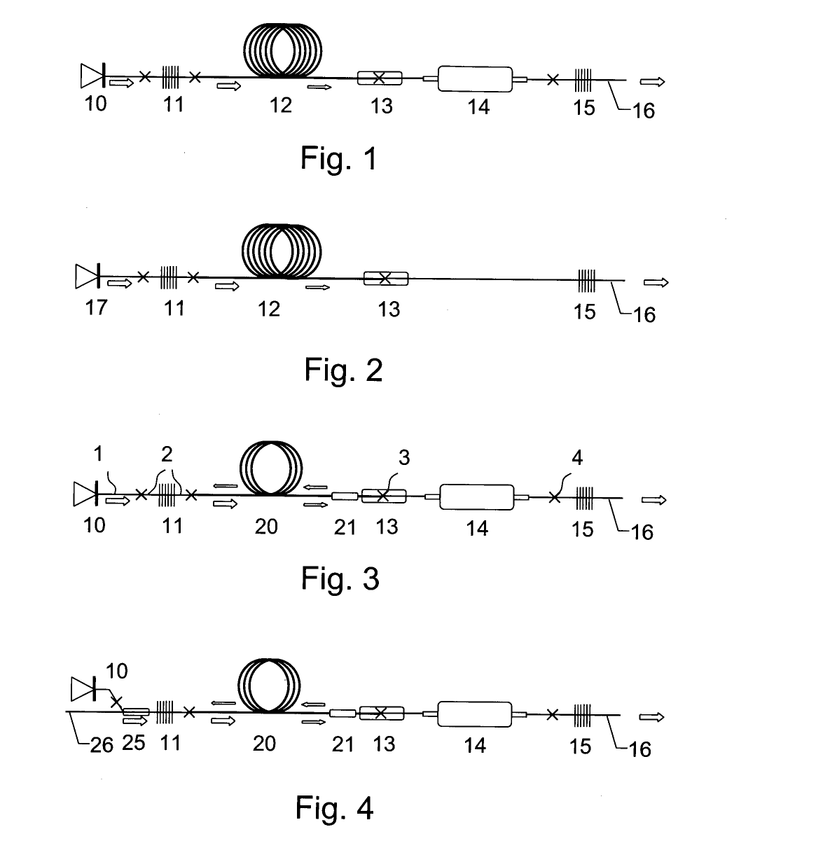

FIG. 1 shows schematically a pulsed fiber laser of active and/or passive Q-switching type, in accordance with the known art;

FIG. 2 shows schematically a pulsed fiber laser of gain switching type, in accordance with the known art;

FIG. 3 shows schematically a pulsed fiber laser of active and/or passive Q-switching type and of the gain switching type, in accordance with the present invention;

FIG. 4 shows schematically a pulsed fiber laser of active and/or passive Q-switching type and of the gain switching type, in accordance with another embodiment of the present invention;

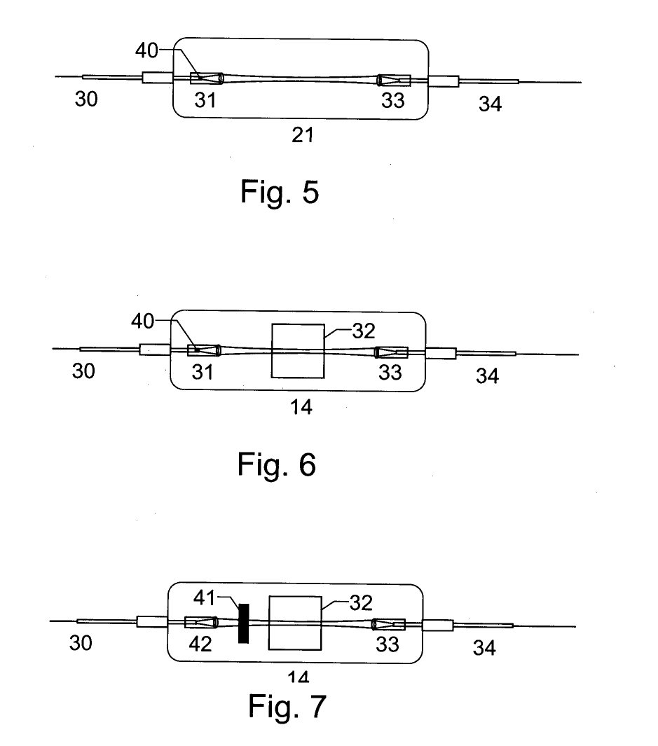

FIG. 5 shows schematically a pumping radiation reflector, in accordance with the present invention;

FIG. 6 shows schematically an opto-acoustic modulator including the pumping radiation reflector, in accordance with the present invention;

FIG. 7 shows schematically an opto-acoustic modulator including the pumping radiation reflector, in accordance with a further embodiment of the present invention;

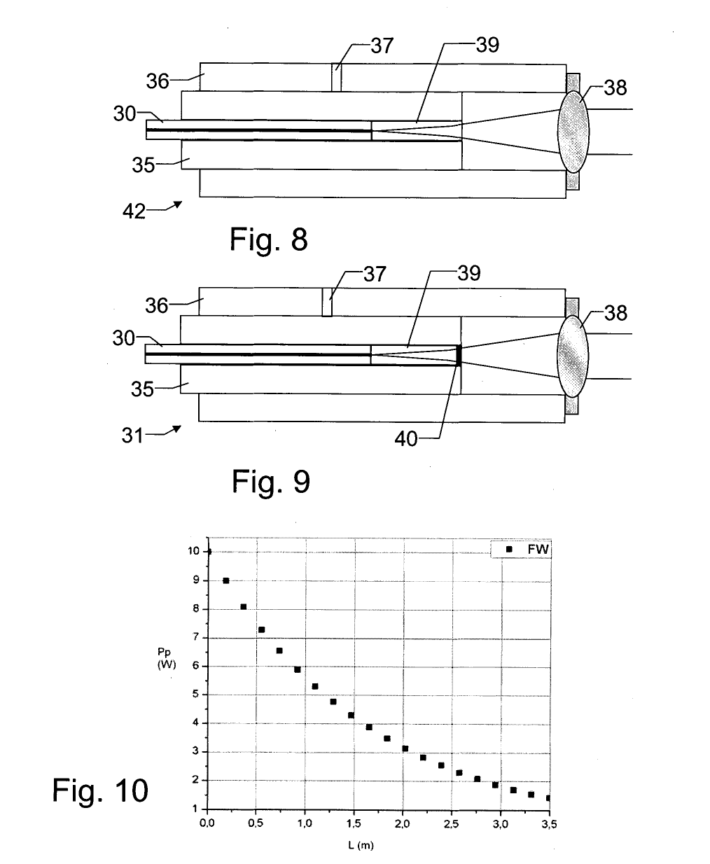

FIG. 8 shows schematically an inlet collimator of the opto-acoustic modulator, in accordance with the known art;

FIG. 9 shows schematically an opto-acoustic modulator including the pumping radiation reflector, in accordance with the present invention;

FIG. 10 shows a graph of the pumping radiation power along the active fiber, in accordance with the known art;

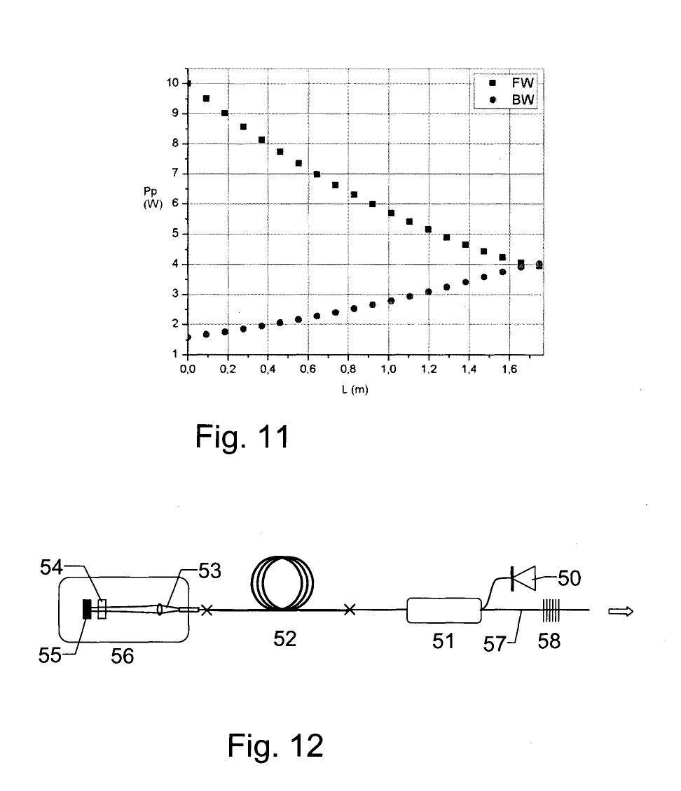

FIG. 11 shows a graph of the pumping radiation power along the active fiber, in accordance with the present invention;

FIG. 12 shows schematically a pulsed fiber laser, in accordance with a further embodiment of the present invention.

With reference to the accompanying figures, a pulsed fiber laser of Q-switching type, in accordance with the known art, comprises a pumping source 10, in this case a pumping diode of 10 W at 915 nm, followed by a fiber Bragg grating (FBG) 11 which reflects at a wavelength of 1064 nm with a percentage of 99% (and in any event greater than 95%), followed by an Ytterbium-doped active fiber 12 with double cladding along 3.5 m with a total absorption at a wavelength of 915 nm equal to 8 db (single passage).

After the fiber 12, a pumping radiation dispersion device 13 (cladding mode stripper) is positioned to prevent the radiation from reaching the following opto-acoustic modulator 14.

This is followed by a further fiber Bragg grating (FBG) 15 which reflects at a wavelength of 1064 nm with a percentage of 8% (between 4% and 20%). The radiation leaving the Bragg grating 15 is fed to an exit fiber 16.

With a laser of this type, which has a total length of 5.1 m, pulses of 100 ns can be obtained at a repetition frequency of 20 kHz with a pumping laser current of 4.5 A, i.e. a pumping power of 3.7 W (45% of the pumping current), (100-20-4.5); or 200 ns at a repetition frequency of 100 kHz with a pumping laser current of 10 A, i.e. a pumping power of 9.0 W (100% of the pumping current), (200-100-10).

While a pulsed fiber laser of Q-switching type, according to the present invention, comprises a pumping source 10 which provides pumping energy to a single clad multimode optical fiber 1 of internal core diameter>100 micron, in the present case the pumping diode emits a power between 2 and 20 W at a wavelength of 915 nm or 940 nm. The fiber 1 is fused with a double clad single mode fiber 2 or at most a nearly single mode (V-number<3) on which a fiber Bragg grating (FBG) 11 is provided which reflects at a wavelength of 1064 nm with a percentage of 99% (and in any event greater than 95%). From the opposite side to the fiber pumping diode 10, the fiber of the Bragg grating 11 is fused with the active fiber 20. This fiber 20 is an Ytterbium doped double clad single mode fiber or at most a nearly single mode (V-number<3) of length 1.75 m with a total absorption at the wavelength 915 nm equal to 8 dB (double passage). That is an active fiber length equal to one half of that used in the known art.

Following the reduced length active optical fiber 20 there is a reflector 21 for the pumping radiation at a wavelength of 915 nm and 940 nm having a reflectivity of 99% and in any event greater than 95%. At the same time the reflector 21 has a transmittance at wavelength 1064 nm of 99% and in any event greater than 95%.

Preferably, but not necessarily, this is followed by a pumping radiation dispersion device 13 (cladding mode stripper).

This is followed by an opto-acoustic modulator 14, for example with internal losses less than 2.0 dB, extinction ratio 50 dB based on a fiber fused to the rest of the optical fiber chain at points 3 and 4. A further fiber Bragg grating (FBG) 15 is then positioned, its fiber being fused to the fiber of the opto-acoustic modulator 14 at 4, which reflects at a wavelength of 1064 nm with a percentage of 8% (between 4% and 20%). The radiation leaving the Bragg grating 15 is fed to an exit fiber 16. The fusion points between the fibers are prepared such as to have the least insertion losses within the oscillator (<0.01 v dB).

The reflector 21 reflects the pumping energy at the wavelength of 915 nm or 940 nm such that it undergoes two passages within the active fiber. A direct first passage and a return second passage reflected by the reflector 21.

The opto-acoustic modulator 14 is an electronically controlled active modulator, as an alternative to this modulator another active modulator of electro-optical type can be used, or a passive modulator can be used, for example a saturable absorber such as Cr4+:YAG. Each of these modulators acts as a wavelength switch at 1064 nm.

With a laser of this type which in total has a length of only 3.35 m, with a reduction of 35% on the known art, pulses of 65 ns can be obtained at a repetition frequency of 20 kHz, with a pumping laser current of 4.5 A, i.e. a pumping power of 3.7 W (45% of the pumping current), (65-20-4.5); or of 100 ns at a repetition frequency of 20 kHz, with a pumping laser current of about 3.3 A, i.e. a pumping power of 2.4 W (33% of the pumping current), (100-20-3.3); or of 130 ns at a repetition frequency of 100 kHz, with a pumping laser current of 10 A, i.e. a pumping power of 9.0 W (100% of the pumping current), (130-100-10); or of 200 ns at a repetition frequency of 100 kHz, with a pumping laser current of 5.2 A, i.e. a pumping power of 4.3 W (52% of the pumping current), (200-100-5.2).

As is known from the theoretical model of the pulsed regime fiber laser, the total length of the Q-switching fiber laser can be further reduced, for example by reducing the modulator terminal fiber portions by connecting the active fiber and the Bragg grating filter directly to the modulator, hence reducing it by about a further 90 cm, to obtain further performance improvements. Pulses of 47 ns are obtained at a repetition frequency of 20 kHz, with a pumping laser current of 4.5 A, i.e. a pumping power of 3.7 W (45% of the pumping current), (47-20-4.5); or of 100 ns at a repetition frequency of 20 kHz, with a pumping laser current of 2.5 A, i.e. a pumping power of 1.7 W (25% of the pumping current), (100-20-2.5); or of 95 ns at a repetition frequency of 100 kHz, with a pumping laser current of 10 A, i.e. a pumping power of 9.0 W (100% of the pumping current), (95-100-10); or of 150 ns at a repetition frequency of 100 kHz, with a pumping laser current of 5.2 A, i.e. a pumping power of 4.3 W (52% of the pumping current), (150-100-5.2).

Preferably, to prevent the returning pumping radiation from interfering with (or damaging) the pumping laser 10, the pumping laser 10 is connected to the fiber Bragg grating 11 by a combiner 25, so that the returning radiation is preferentially lost in the fiber 26.

The opto-acoustic modulator 14 is used as a beam time switch to create a pulsed beam and not as a wavelength selector, and is formed with an entry fiber 30, typically with double cladding (10/125), to which a collimator 42 is connected which transfers the radiation from the fiber to the air, followed by the opto-acoustic cell 32 of the opto-acoustic modulator, a further collimator 33 for returning the radiation to the fiber and an exit fiber 34, typically with double cladding (10/125).

The collimator 42 comprises a fiber 30 inserted into a zirconium sleeve 35. The fiber 30 and the sleeve 35 terminate aligned frontally. The sleeve 35 is inserted into a stainless steel tube 36 which is fixed by adhesive which filers through the hole 37 to hence block advancement of the sleeve 35 before the termination of the tube 36, such that the fiber 30 lies at a correct distance from the collimating lens 38 positioned at the end of the tube 36.

In this specific embodiment of the collimator, dedicated to peak powers exceeding 100 W, an end cap 39 must be welded to the fiber to reduce the optical flow to well below the damage threshold typically of 10 J/cm² for dielectric coating.

In accordance with one embodiment of the present invention, the fiber 30 terminates aligned with the sleeve 35 of the collimator 31, with this latter blocked by the glue which filters through the hole 37 at a predetermined distance from the lens 38, the pumping signal reflector 21 being formed by an anti-reflection coating 40, typical dielectric, formed on the front surface of the fiber 30, the anti-reflection coating 40 also being applied to the front surface of the end cap 39 if this is present.

The coating 40 reflects (R>99%) the radiation at 915 nm present in the cladding but does not reflect (R<1.0%) the radiation at 1064 nm present in the fiber core. In the present embodiment, the diameter of the beam expanded by the end cap at the dielectric layer surface is 60 um, such a value enabling the value of the connected returning radiation at 1064 nm into the fiber core to be limited to below −40 dB. According to another embodiment of the present invention (FIG. 7), the reflector 21 for the pumping signal can be introduced at any point of the optical path after the active fiber and before the reflector 15, more precisely between the active fiber and the opto-acoustic modulator crystal, when the radiation propagation takes place in air within the opto-acoustic modulator. For example, a thin mirror 41 (with reflectivity at 915 nm greater than 95% and transparent for the wavelength of 1964 nm) can be introduced between the collimator 42, which in this case does not have the coating 40, and the opto-acoustic cell 32. In this manner the formation of the collimator is not complicated but a device has to be created which supports the mirror 41 and enables its correct alignment for retroreflection of the pumping radiation, before fixing by adhesive.

According to a further embodiment of the present invention (FIG. 5), instead of introducing the reflector into the modulator, a reflecting device 21 can be achieved by forming an optical entry collimator 31 having a coating 40 on the front surface of the fiber 30 which reflects the pumping radiation and an exit collimator 33 suitably aligned with the collimator 31. In this case the reflecting device 21 can be inserted into the laser chain after the active fiber 20, for example in the case of a Gain-switching oscillator which does not comprise a modulator 14. As an alternative to the optical entry collimator 31 with the coating 40, a thin mirror 41 can be introduced between the two normal collimators 42 and 33.

A further embodiment of the pumping radiation reflecting system could be achieved by specifically working the layer of fiber cladding such as to intercept the residual pumping radiation and reflect it towards the active fiber 20. In this manner there is the advantage of eliminating the fiber-air passage.

With a pulsed fiber laser of the known art, it can be seen from FIG. 10 that the pumping power Pp, in its passage within the active fiber, progressively decreases along the entire length of the fiber. With an initial power of 10 W, this decreases down to about 1 W along the 3.5 m length of the fiber.

In contrast, in the case of a pulsed fiber laser of Q-switching type, according to the present invention, it can be seen from FIG. 11 that again starting from an initial power of 10 W the power decreases progressively during forward propagation (FW) until it reaches a power of about 4 W at the end of the fiber length, now 1.75 m, and then a further power reduction during backward propagation (BW) after reflection, to reach a final power of about 1 W at the commencement of the fiber.

The choice of the length of the active fiber 20, shorter than the length of the known art, can be determined such that the power exiting the pumping source 10 is completely (or nearly completely) absorbed by said active optical fiber during the forward and backward double passage.

The solution described here is also applicable to the gain switching technique, where the modulator 14 is not present and the pumping diode 17 is current modulated by providing a pulsed radiation. In this case the 1064 nm wavelength switch is no longer the modulator but the diode command signal which is a digital on-off signal. This pulsed pumping signal modulates the gain of the active fiber 20. The reflector 21, such as that of FIG. 5, can be introduced after the active fiber 20.

A further embodiment of an oscillator according to the present invention (FIG. 12) comprises: a continuous pumping diode 50, connected to a fiber combiner 51, which transfers the pumping radiation to an active fiber 52 terminating with a collimator 53 (of the same type as the collimator 31) which reflects the pumping radiation and transmits the 1064 nm radiation in air to an active or passive modulator 54, and a reflective element 55 (with reflectivity exceeding 95% at 1064 nm), which must be aligned to retroreflect the 1064 nm radiation into the fiber. If the modulator is of passive type, for example Cr4+:YAG, this reflective element could be a dielectric coating deposited directly on the crystal surface, more precisely on its rear surface, considering the front to be that surface facing the collimator 53. Preferably the collimator 53 and the modulator 54 are enclosed in a box 56. The fiber combiner 51 on the side of the pumping diode 50 is connected to a fiber 57 at which a filter of fiber Bragg grating type 58 is provided with a reflectivity for 1064 nm radiation typically of 8%.

The opportunity for reflecting the pumping radiation subsequent to an active optical fiber, in order to reduce the length of this latter, can also be applied in fiber laser amplifiers. As a laser amplifier normally terminates in air, to launch the exit radiation towards the processed object, this fiber air interface can be utilized to form the reflecting device for the amplifier pumping radiation.

With a pulsed fiber laser defined as aforedescribed, by using a pumping radiation reflector to achieve a double passage of the pumping radiation within the active fiber, and hence using a shorter active fiber, the present solution is susceptible to numerous modifications and variants, all falling with the scope of the inventive concept; moreover all details can be replaced by technically equivalent elements.

1. A pulsed fiber laser oscillator comprising in succession: a pumping source (10) for providing pumping energy at a first wavelength to a muitimode optical fiber; a first Bragg grating optical filter (11) reflecting a second wavelength and transparent to said first wavelength; an active optical fiber (20) having a predefined wavelength which emits radiation at said second wavelength; a switch (14) arranged to periodically interrupt said second wavelength to provide a pulsed laser beam; and a second Bragg grating optical filter (15) partially reflecting said second wavelength; characterized by comprising, following said active optical fiber (20), a reflector (21) of said first wavelength, such that said pumping energy undergoes two passages within said active optical fiber (20); said predefined wavelength being determined such that the absorption of said pumping energy at said first wavelength within said active optical fiber (20) is greater than 80% after undergoing said two passages.

2. A laser oscillator as claimed in claim 1, characterized in that said switch (14) is an optical switch, it being an opto-acoustic modulator, said opto-acoustic modulator containing said reflector (40, 41) of said first wavelength.

3. A laser oscillator as claimed in claim 2, characterized in that said opto-acoustic modulator (14) comprises an entry collimator (42); said entry collimator (42) comprising an inlet fiber having its front surface covered with a reflective coating (40) for said first wavelength.

4. A laser oscillator as claimed in characterized in that said switch (14) is an electrical switch which periodically interrupts the current feeding said pumping source (10).

5. A laser oscillator as claimed claim 1, characterized in that said reflector (21) of said first wavelength has a reflectivity of said first wavelength greater than 95%.

6. A laser oscillator as claimed claim 1, characterized in that said reflector (21) of said first wavelength has a transmittance of said second wavelength greater than 95%.

7. A laser oscillator as claimed claim 1, characterized in that said first optical filter (11) is a Bragg grating filter having a reflectivity of said second wavelength greater than 95%.

8. A laser oscillator as claimed claim 1, characterized in that said second optical filter (15) is a Bragg, grating filter having a reflectivity of said second wavelength between 4% and 20%, typically 8%.

9. A laser oscillator as claimed claim 1, characterized in that said predefined length of said active optical fiber (20) is determined such that the power exiting the pumping source (10) is absorbed by said active optical fiber (20) during its forward and backward propagation.

10. A laser oscillator as claimed claim 1, characterized in that said reflector (21) of said first wavelength comprises an entry collimator (31); said entry collimator (31) comprising an inlet fiber having its front surface covered with a reflective coating for said first wavelength.

11. A method for producing a pulsed fiber laser in accordance with claim 1.
